(19) United States
(12) Patent Application Publication
(10) Pub. No.: US 2009/0275694 A1
(43) Pub. Date: Nov. 5, 2009

(54) Spin-on-Glass Anti-Reflective Coatings for Photolithography

(75) Inventors: Teresa Baldwin-Hendricks, Livermore, CA (US); Joseph T. Kennedy, San Jose, CA (US); Mary E. Richey, Jefferson, MA (US)

Correspondence Address: BUCHALTER NEMER, 18400 VON KARMAN AVE., SUITE 800, IRVINE, CA, 92612, US

(73) Assignee: HONEYWELL INTERNATIONAL INC., Morristown, NJ (US)

(21) Appl. No.: 10/495,687

(22) PCT Filed: Nov. 16, 2001
(86) PCT No.: PCT/US01/43831

§ 371 Date: Feb. 5, 2009

(51) Int. Cl. C08L 83/04; C08G 77/12; G02B 5/22

(52) U.S. Cl. 524/588; 528/31; 252/589

(57) ABSTRACT

The present invention provides a siloxane polymer family comprising siloxane polymer made from: (a) a strongly absorbing compound; (b) at least one silane having good leaving groups; and (c) at least one silane having good leaving groups that is different than (b); wherein the siloxane polymer family exhibits a relationship that is concave/convex or is located in the region enclosed by a concave/convex relationship for the ratio of (a) to (b) to (c) and the siloxane polymer's extinction coefficient k value. These siloxane polymers are preferably used as spin-on glass compositions for films in the microelectronics applications.

### TECHNICAL FIELD OF THE INVENTION

The present invention relates generally to spin-on glass materials and more specifically to light-absorbing spin-on glass materials for use as anti-reflective layers in photolithography and methods of producing the materials.

### BACKGROUND OF THE INVENTION

To meet the requirements for faster performance, the characteristic dimensions of features of integrated circuit devices have continued to be decreased. Manufacturing of devices with smaller feature sizes introduces new challenges in many of the processes conventionally used in semiconductor fabrication. One of the most important of these fabrication processes is photolithography.

It has long been recognized that linewidth variations in patterns produced by photolithography may result from optical interference from light reflecting off an underlying layer on a semiconductor wafer. Variations in photoresist thickness due to the topography of the underlying layer also induce linewidth variations. Anti-reflective coatings (ARC) applied under a photoresist layer have been used to prevent interference from reflection of the irradiating beam. In addition, anti-reflective coatings partially-planarize the wafer topography, helping to improve linewidth variation over steps because-the photoresist thickness is more uniform.

Organic polymer films, particularly those that absorb at the i-line (365 nm) and g-line (436 nm) wavelengths conventionally used to expose photoresists, and at the recently used 248 nm wavelength, have been employed as anti-reflective coatings. However, the fact that the organic ARC's share many chemical properties with the organic photoresists can limit usable process sequences. Furthermore organic ARC's may intermix with photoresist layers. One solution to avoid intermixing, is to introduce thermosetting binders as additional components of organic ARC's, as described, for example in U.S. Pat. No. 5,693,691. Dyes may also be incorporated in organic ARC's, as well as, optionally, additional additives such as wetting agents, adhesions promoters, preservatives, and plasticizers, as described in U.S. Pat. No. 4,910,122.

Silicon oxynitride is another material that has been used as an anti-reflective coating. However, silicon oxynitride works as an ARC by a destructive interference process rather than by absorption, which means that very tight control of the oxynitride thickness is necessary and that the material may not work well as an ARC over highly variable topography. Furthermore silicon oxynitride is typically deposited by chemical vapor deposition, while photoresist layers are typically applied using a spin-coater. The additional chemical vapor deposition process can add to processing complexity.

Yet another class of materials that can be used as an anti-reflective layer is spin-on-glass (SOG) compositions containing a dye. U.S. Pat. No. 4,587,138 discloses a dye such as basic yellow #11 mixed with a spin-on-glass in an amount approximately 1% by weight. U.S. Pat. No. 5,100,503 discloses a cross-linked polyorganosiloxane containing an inorganic dye such as TiO₂, Cr₂O₇, MoO₄, MnO₄, or ScO₄, and an adhesion promoter and additionally teaches that the spin-on-glass compositions also serve as a planarizing layer. However, the spin-on-glass, dye combinations that have been disclosed to date are not optimal for exposure to the deep ultraviolet, particularly 248 and 193 nm, light sources that are coming into use to produce devices with small feature sizes. Furthermore, not all dyes can be readily incorporated into an arbitrary spin-on-glass composition.

Honeywell Accuglass® 108 product comprises methylphenylsiloxane and an incorporatable organic absorbing compound and has a k (at 193 nanometers) of 0.106 to 0.094. Honeywell Accuglass 204® product comprises methylphenylsiloxane and an incorporatable organic absorbing compound and has a k (at 193 nanometers) of 0.268-0.236. Honeywell Accuglass® 720 material comprises methylphenylsilsequioxane of the general formula (R_{0-1.0})(SiO_{1.5-2.0})ₘ and an incorporatable organic absorbing compound and has a k (at 193 nanometers) of 0.6 to 0.65 but has an inadequate etch rate.

Our U.S. Pat. No. 6,268,457B1 teaches an improved spin-on glass anti-reflective coating comprising at least organic dye useful for deep ultraviolet photolithography and teaches ten different useful dyes having at least two fused or unfused benzene rings.

Subsequent to the work in our U.S. Pat. No. 6,268,457B1 and prior to the present invention, we undertook an experiment wherein we varied the amount of dye and maintained constant all other amounts of starting materials. The resulting linear relationship between the amount of dye present and the extinction coefficient k is plotted in FIG. 1.

### SUMMARY OF THE INVENTION

We have now discovered that phenylalkoxysilane (has one benzene ring) may function as both a strongly absorbing compound and a silane starting material for siloxane polymer and thus, the addition of an organic dye as taught by our U.S. Pat. No. 6,268,457B1 is not required in order to make a spin-on glass composition that is strongly absorbing. In particular, phenylalkoxysilane is strongly absorbing at wavelengths less than about 200 nanometers.

Thus, the present invention provides a siloxane polymer made from
(a) phenylalkoxysilane that strongly absorbs light at wavelengths less than about 365 nanometers; and
(b) at least one silane having good leaving groups.

Contrary to the expected linear relationship in FIG. 1, we have also discovered a siloxane polymer family wherein a non-linear relationship and more specifically, a saddle or concave/convex shaped relationship exists between the composition's extinction coefficient value and the ratio of the starting silanes used to make the siloxane polymer. Furthermore, this novel siloxane polymer family also exhibits a concave/convex shaped relationship between the composition's etch rate.

Thus, for any given extinction coefficient k value, two different ratios of starting silanes exist and one may select the starting ratio that provides the most advantageous siloxane polymer properties. For example, it is known that as the amount of an aromatic compound increases in a composition, the composition's etch rate undesirably increases. In the present invention, one may advantageously achieve the same extinction coefficient k value in a composition by using a decreased amount of an aromatic compound, in this case the strongly absorbing compound, and an increased amount of another starting silane compound and thus, also improve the siloxane polymer's etch rate or another desirable property.

Thus, the present invention also provides a siloxane polymer family comprising siloxane polymer made from:
(a) a strongly absorbing compound;
(b) at least one silane having a good leaving group;
(c) at least one silane having a good leaving group that is different than (b),
   wherein said siloxane polymer family exhibits a concave/convex shaped relationship or is located in the region enclosed by a concave/convex shaped relationship for the ratio of (a) to (b) to (c) and the siloxane polymer's k value.

The present invention provides a method of achieving a composition having tuned optical properties and maximum etch rate comprising the steps of:
(a) using a siloxane polymer family comprising siloxane polymer made from:
(i) a strongly absorbing compound;
(ii) at least one silane having good leaving groups; and
(iii) at least one silane having good leaving groups that is different than (ii),
   wherein said siloxane polymer family exhibits a concave/convex shaped relationship or is located in the region enclosed by a concave/convex relationship for the ratio of said (i) to said (ii) to said (iii) and said siloxane polymer's extinction coefficient k value;
(b) selecting a extinction coefficient k value; and
(c) selecting the ratio of said (i) to said (ii) to said (iii) that optimizes another property of said siloxane polymer.

### BRIEF DESCRIPTION OF THE DRAWINGS

FIG. 1 is a plot of the expected linear relationship between extinction coefficient k value and the amount of strongly absorbing compound present in a composition.

FIGS. 2a-2c illustrate the chemical formulas of absorbing compounds incorporated into spin-on-glass compositions, according to embodiments of the present invention.

FIGS. 3a-3h illustrate the use of absorbing spin-on-glass compositions, according to embodiments of the present invention as anti-reflective coating layers in a photolithography process.

FIG. 4 shows for the inventive siloxane polymer family (absorbing at 193 nanometers) the concave/convex shaped relationship that exists between extinction coefficient k and the ratio of the starting silanes.

FIG. 5 shows for the inventive siloxane polymer family (absorbing at 193 nanometers) the concave/convex shaped relationship that exists between etch rate and the ratio of the starting silanes.

FIG. 6 shows for the inventive siloxane polymer family (absorbing at 193 nanometers) the concave/convex shaped relationship that exists between refractive index and the ratio of the starting silanes.

FIG. 7 shows for the inventive siloxane polymer family (absorbing at 248 nanometers) the concave/convex shaped relationship that exists between extinction coefficient k and the ratio of the starting silanes.

FIG. 8 shows for the inventive siloxane polymer family (absorbing at 248 nanometers) the concave/convex shaped relationship that exists between refractive index and the ratio of the starting silanes.

### DETAILED DESCRIPTION OF THE INVENTION

The phrase “good leaving group” as used herein means a group that is likely to leave during a reaction. Preferred good leaving groups include alkoxy groups, acetoxy groups, and halogens.

### Silanes:

Preferably, the present compositions are synthesized from silane reactants having good leaving groups such as triethoxysilane (“HTEOS”), tetraethoxysilane (“TEOS”), methyltriethoxysilane (“MTEOS”), dimethyldiethoxysilane, tetramethoxysilane (“TMOS”), methyltrimethoxysilane (“MTMOS”), trimethoxysilane, dimethyldimethoxysilane, phenyltriethoxysilane (“PTEOS”), phenyltrimethoxysilane (“PTMOS”), diphenyldiethoxysilane, and diphenyldimethoxysilane. Halosilanes, particularly chlorosilanes, for example, trichlorosilane, methyltrichlorosilane, ethyltrichlorosilane, phenyltrichlorosilane, tetrachlorosilane, dichlorosilane, methyldichlorosilane, dimethyldichlorosilane, chlorotriethoxysilane, chlorotrimethoxysilane, chloromethyltriethoxysilane, chloroethyltriethoxysilane, chlorophenyltriethoxysilane, chloromethyltrimethoxysilane, chloroethyltrimethoxysilane, and chlorophenyltrimethoxysilane are also used as silane reactants. Perhydrosilazane is also useful.

### Strongly Absorbing Compounds:

As used herein, the term “phenyalkoxysilane” means any compound having phenyl directly linked to silicon or linked to silicon through a one to ten carbon bridge. Preferred phenylalkoxysilanes include phenyltrimethoxysilane (PTMOS), phenyltriethoxysilane (PTEOS), phenyltributoxysilane, and phenyltripropoxysilane.

Useful strongly absorbing compounds include those that are strongly absorbing preferably over at least an approximately 5 nanometer wide wavelength range and, more preferably over an approximately 10 nm wide wavelength range around wavelengths such as 248 nm, 193 nm, or other ultraviolet wavelengths, such as 365 nm, that may be used in photolithography. The chromophores of suitable compounds typically have from one to three benzene rings that may or may not be fused. Incorporatable absorbing compounds have an accessible reactive group attached to the chromophore, the reactive groups including hydroxyl groups, amine groups, carboxylic acid groups, and substituted silyl groups with silicon bonded to one, two, or three alkoxy group, acetoxy group, or halogen atom substituents. The reactive groups may be directly bonded to the chromophore or the reactive groups may be attached to the chromophore through a hydrocarbon bridge.

Many naphthalene- and anthracene-based compounds have significant absorption at 248 nm and below. Benzene-based, equivalently termed here phenyl-based, compounds have significant absorption at wavelengths shorter than 200 nm. While these naphthalene-, anthracene-, and phenyl-based compounds are frequently referred to as dyes, the term absorbing compound is used here because the absorptions of these compounds are not limited to wavelengths in the visible region of the spectrum. However, not all such absorbing compounds can be incorporated into spin-on-glasses for use as ARC materials. Absorbing compounds suitable for use with the present invention have an absorption peak over at least an approximately 10 nm wide wavelength range centered around wavelengths such as 248 nm, 193 nm, or other ultraviolet wavelengths, such as 365 nm, that may be used in photolithography. Absorbing compounds which only have narrow absorption peaks, for example, less than 2 nm wide, around these wavelengths are not as desirable.

The chromophores of suitable absorbing compounds typically have one, two, or three benzene rings that may or may not be fused. Incorporatable absorbing compounds have an accessible reactive group attached to the chromophore, the reactive groups including hydroxyl groups, amine groups, carboxylic acid groups, and substituted silyl groups with silicon bonded to one, two, or three “leaving groups,” such as alkoxy groups, acetoxy groups, or halogen atoms. Ethoxy or methoxy groups or chlorine atoms are frequently used as leaving groups. Useful acetoxy groups include tetraacetoxysilane and methyltriacetoxysilane. Thus, suitable reactive groups include siliconethoxy, silicondiethoxy, silicontriethoxy, siliconmethoxy, silicondimethoxy, silicontrimethoxy, chlorosilyl, dichlorosilyl, and trichlorosilyl groups. The reactive groups may be directly bonded to the chromophore, as, for example, in phenyltriethoxysilane, or the reactive groups may be attached to the chromophore through a hydrocarbon bridge, as, for example, in 9-anthracene carboxy-methyl triethoxysilane. The inclusion of silicontriethoxy groups on chromophores, for example, has been found to be advantageous, especially for promoting stability of the absorbing SOG films. Absorbing compounds containing an azo group, —N═N—, and an accessible reactive group, particularly those containing an azo group linking benzene rings, are also useful, especially when absorption around 365 nm is desired.

Examples of suitable organic absorbing compounds include 9-anthracene carboxy-alkyl di- or trialkoxysilane wherein the alkyl has from 1 to 4 carbon atoms and the alkoxy has from 1 to 4 carbon atoms and 9-anthracene carboxy-alkyl di- or trihalogen silane wherein the alkyl has from 1 to 4 carbon atoms, and mixtures thereof.

The 9-anthracene carboxyl-alkyl di- or trialkoxysilanes wherein the alkyl has from 1 to 4 carbon atoms and the alkoxy has from 1 to 4 carbon atoms include 9-anthracene carboxyl-methyl dimethoxysilane, 9-anthracene carboxyl-ethyl dimethoxysilane, 9-anthracene carboxyl-propyl dimethoxysilane, 9-anthracene carboxyl-butyl dimethoxysilane, 9-anthracene carboxyl-methyl diethoxysilane, 9-anthracene carboxyl-ethyl diethoxysilane, 9-anthracene carboxyl-propyl diethoxysilane, 9-anthracene carboxyl-butyl diethoxysilane, 9-anthracene carboxyl-methyl dipropoxysilane, 9-anthracene carboxyl-ethyl dipropoxysilane, 9-anthracene carboxyl-propyl dipropoxysilane, 9-anthracene carboxyl-butyl dipropoxysilane, 9-anthracene carboxyl-methyl dibutoxysilane, 9-anthracene carboxyl-ethyl dibutoxysilane, 9-anthracene carboxyl-propyl dibutoxysilane, 9-anthracene carboxy-butyl dibutoxysilane, 9-anthracene carboxyl-methyl trimethoxysilane, 9-anthracene carboxyl-ethyl trimethoxysilane, 9-anthracene carboxy-propyl trimethoxysilane, 9-anthracene carboxy-butyl trimethoxysilane, 9-anthracene carboxy-methyl triethoxysilane, 9-anthracene carboxy-ethyl triethoxysilane, 9-anthracene carboxy-propyl triethoxysilane, 9-anthracene carboxy-butyl triethoxysilane, 9-anthracene carboxy-methyl tripropoxysilane, 9-anthracene carboxy-ethyl tripropoxysilane, 9-anthracene carboxy-propyl tripropoxysilane, 9-anthracene carboxy-butyl tripropoxysilane, 9-anthracene carboxy-methyl tributoxysilane, 9-anthracene carboxy-ethyl tributoxysilane, 9-anthracene carboxy-propyl tributoxysilane, and 9-anthracene carboxy-butyl tributoxysilane.

The 9-anthracene carboxy-alkyl di- or trihalogen silanes wherein the alkyl has from 1 to 4 carbon atoms includes 9-anthracene carboxy-methyl dibromosilane, 9-anthracene carboxy-ethyl dibromosilane, 9-anthracene carboxy-propyl dibromosilane, 9-anthracene carboxy-butyl dibromosilane, 9-anthracene carboxy-methyl dichlorosilane, 9-anthracene carboxy-ethyl dichlorosilane, 9-anthracene carboxy-propyl dichlorosilane, 9-anthracene carboxy-butyl dichlorosilane, 9-anthracene carboxy-methyl difluorosilane, 9-anthracene carboxy-ethyl difluorosilane, 9-anthracene carboxy-propyl difluorosilane, 9-anthracene carboxy-butyl difluorosilane, 9-anthracene carboxy-methyl tribromosilane, 9-anthracene carboxy-ethyl tribromosilane, 9-anthracene carboxy-propyl tribromosilane, 9-anthracene carboxy-butyl tribromosilane, 9-anthracene carboxy-methyl trichlorosilane, 9-anthracene carboxy-ethyl trichlorosilane, 9-anthracene carboxy-propyl trichlorosilane, 9-anthracene carboxy-butyl trichlorosilane, 9-anthracene carboxy-methyl trifluorosilane, 9-anthracene carboxy-ethyl trifluorosilane, 9-anthracene carboxy-propyl trifluorosilane, and 9-anthracene carboxy-butyl trifluorosilane.

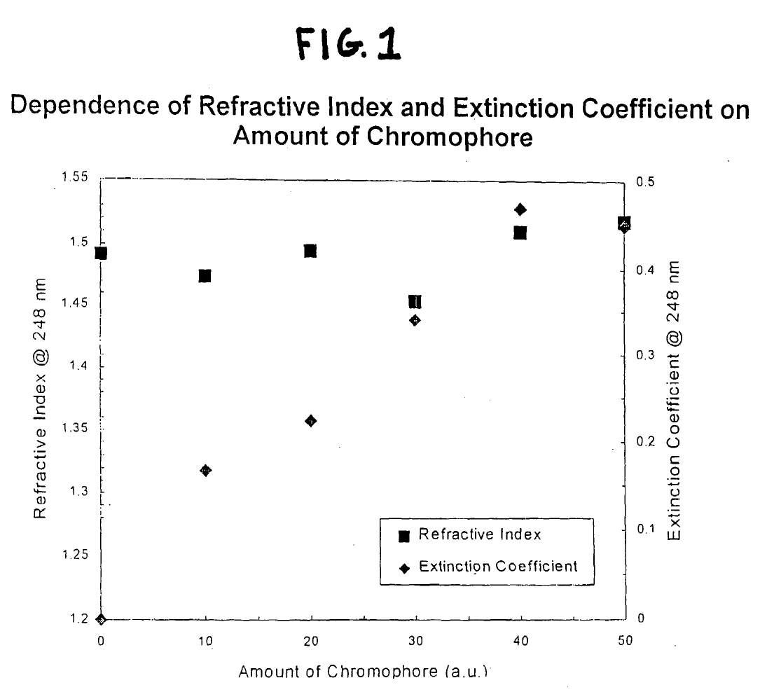

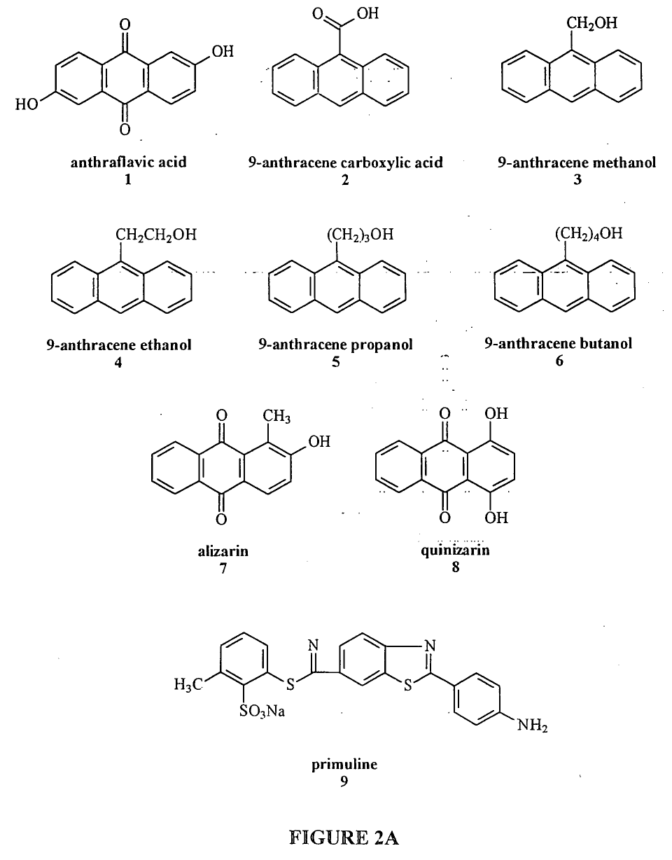

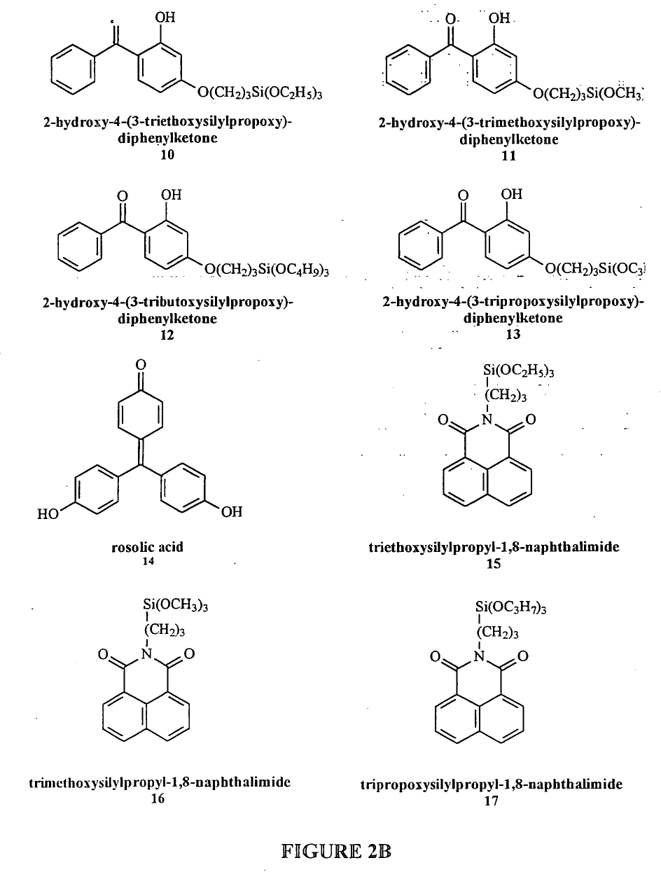

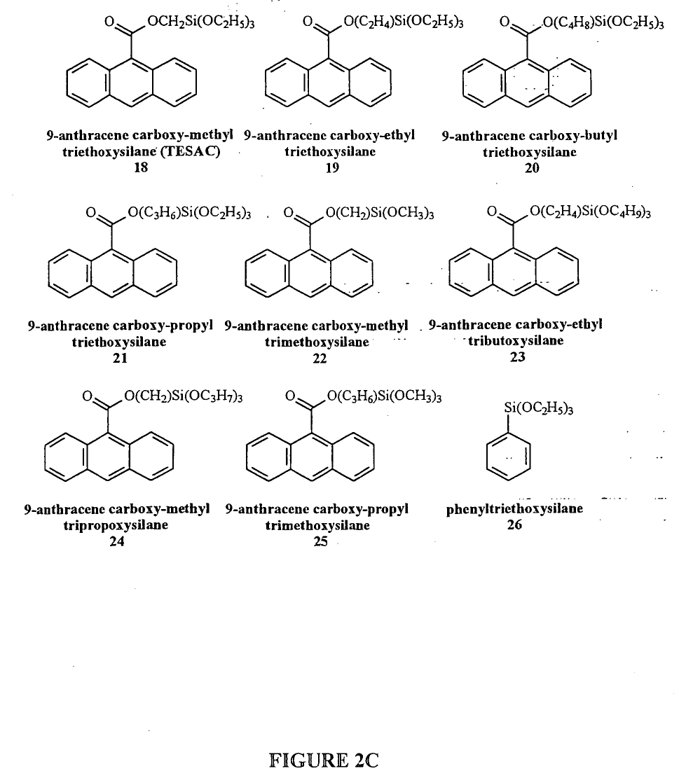

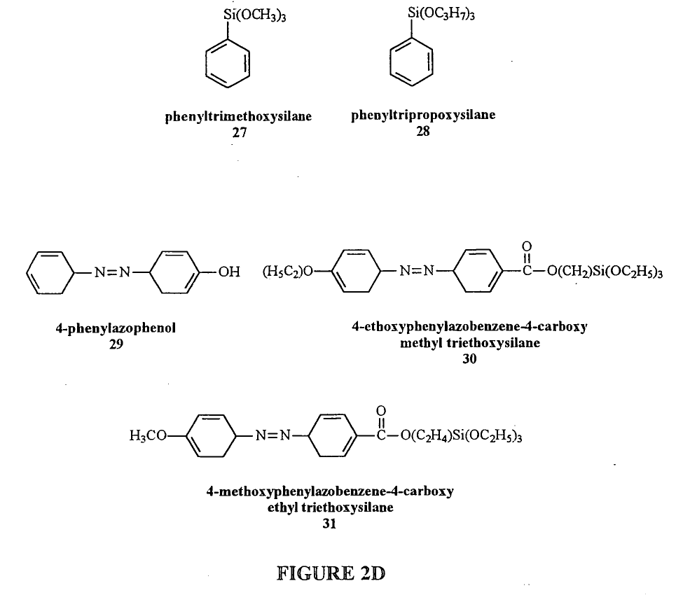

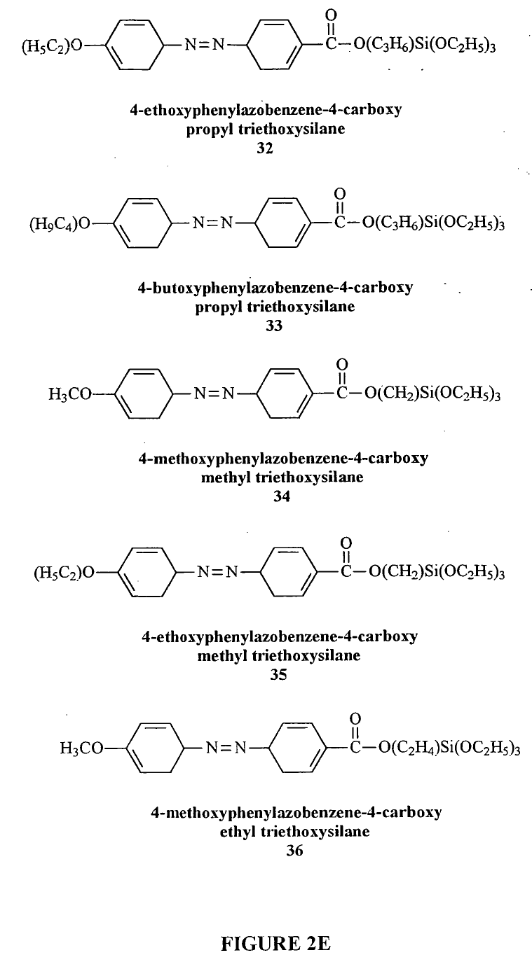

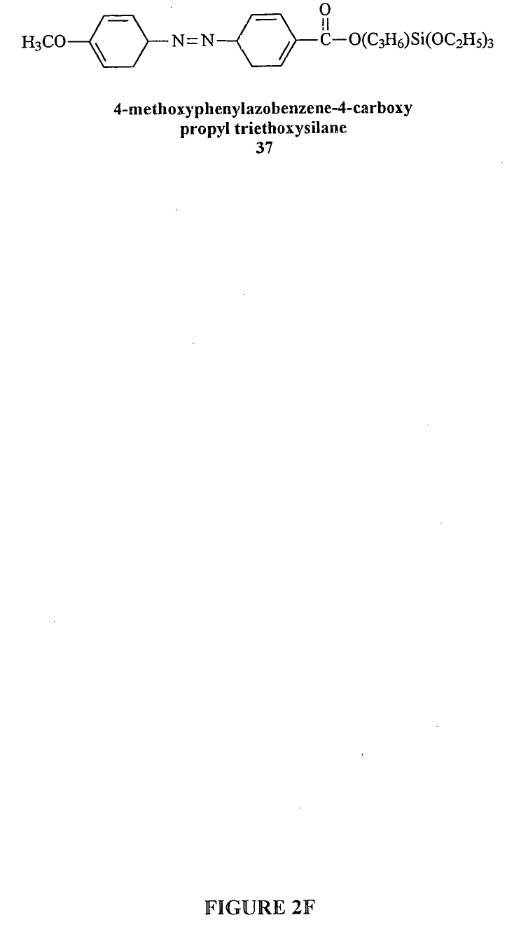

Other examples of absorbing compounds suitable for use with the present invention include anthraflavic acid (1), 9-anthracene carboxylic acid (2), 9-anthracene methanol (3), 9-anthracene ethanol (4), 9-anthracene propanol (5), 9-anthracene butanol (6), alizarin (7), quinizarin (8), primuline (9), 2-hydroxy-4-(3-triethoxysilylpropoxy)-diphenylketone (10), 2-hydroxy-4-(3-trimethoxysilylpropoxy)-diphenylketone (11), 2-hydroxy-4-(3-tributoxysilylpropoxy)-diphenylketone (12), 2-hydroxy-4-(3-tripropoxysilylpropoxy)-diphenylketone (13), rosolic acid (14), triethoxysilylpropyl-1,8-naphthalimide (15), trimethoxysilylpropyl-1,8-naphthalimide (16), tripropoxysilylpropyl-1,8-naphthalimide (17), 9-anthracene carboxy-methyl triethoxysilane (18), 9-anthracene carboxy-ethyl triethoxysilane (19), 9-anthracene carboxy-butyl triethoxysilane (20), 9-anthracene carboxy-propyl triethoxysilane (21), 9-anthracene carboxy-methyl trimethoxysilane (22), 9-anthracene carboxy-ethyl tributoxysilane (23), 9-anthracene carboxy-methyl tripropoxysilane (24), 9-anthracene carboxy-propyl trimethoxysilane (25), phenyltriethoxysilane (26), phenyltrimethoxysilane (27), phenyltripropoxysilane (28), 4-phenylazophenol, (29), 4-ethoxyphenylazobenzene-4-carboxy-methyl triethoxysilane (30), 4-methoxyphenylazobenzene-4-carboxy-ethyl triethoxysilane (31), 4-ethoxyphenylazobenzene-4-carboxy-propyl triethoxysilane (32), 4-butoxyphenylazobenzene-4-carboxy-propyl triethoxysilane (33), 4-methoxyphenylazobenzene-4-carboxy-methyl triethoxysilane (34), 4-ethoxyphenylazobenzene-4-carboxy-methyl triethoxysilane (35), 4-methoxyphenylazobenzene-4-carboxy-ethyl triethoxysilane (36), 4-methoxyphenylazobenzene-4-carboxy-propyl triethoxysilane (37), and combinations, thereof. Chemical formulas of absorbing compounds 1-37 are illustrated in FIGS. 1a-1f. Advantageous results have been obtained, for example, with 9-anthracene carboxy-methyl triethoxysilane (18) with combinations of 9-anthracene methanol (3), 2-hydroxy-4-(3-triethoxysilylpropoxy)-diphenylketone (10), and rosolic acid (14), and with phenyltriethoxysilane (26). It should be appreciated, however, that this list of specific compounds is not an exhaustive list, and that contemplated and preferred compounds can be selected from the chemical compound classes that comprise these specific compounds.

Most of these absorbing compounds are available commercially, for example, from Aldrich Chemical Company (Milwaukee, Wis.). 9-anthracene carboxy-alkyl trialkoxysilanes are synthesized using esterification methods, as described immediately below. Examples of phenyl-based absorbing compounds in addition to absorbing compound include structures with silicon-based reactive groups attached to phenyl rings or to substituted phenyls, such as methylphenyl, chlorophenyl, and chloromethylphenyl. Specific phenyl-based absorbing compounds include phenyltrimethoxysilane, benzyltrichlorosilane, chloromethylphenyltrimethoxysilane, phenyltrifluorosilane, to name only a few examples. Diphenyl silanes including one or two “leaving groups,” such as diphenylmethylethoxysilane, diphenyidiethoxysilane, and diphenyidichlorosilane, to again name only a few examples, are also suitable incorporatable absorbing compounds.

A general method of synthesizing 9-anthracene carboxy-alkyl trialkoxysilane compounds comprises using 9-anthracene carboxylic acid and a chloromethyl trialkoxysilane compound as reactants. Specifically, a method of synthesizing 9-anthracene carboxy-methyl triethoxysilane (18) uses 9-anthracene carboxylic acid (2) and chloromethyl triethoxysilane as reactants. The reactants are combined with triethylamine and methylisobutylketone (MIBK), previously dried over 4 Å molecular sieves, to form a reaction mixture that is heated to reflux and refluxed for from approximately 6 to 10 hours. After reflux, the reaction mixture is cooled overnight leading to a large quantity of solid precipitate. The remaining solution is roto-evaporated, filtered through a silica gel column, and roto-evaporated a second time, to produce 9-anthracene carboxy-methyl triethoxysilane (18) as a dark amber oily liquid, which may be purified. This method is significant because it is suitable to use to produce any compound in the class of 9-anthracene carboxy-alkyl trialkoxysilanes, including 9-anthracene carboxy-ethyl triethyoxysilane (TESAC), 9-anthracene carboxy-propyl trimethoxysilane, and 9-anthracene carboxy-propyl triethyoxysilane (ACTEP).

For spin-on glass compositions absorbing at 193 nanometers, the weight ratio of the (a) starting strongly absorbing compound is from about 22 to about 100; the weight ratio of the (b) silane having good leaving groups is from about 9 to about 98; and the weight ratio of the (c) silane having good leaving groups that is different than (b) is from about 61 to about 162.

For spin-on glass compositions absorbing at 248 nanometers, the weight ratio of the (a) starting strongly absorbing compound is from about 12 to about 60; the weight ratio of the (b) silane having good leaving groups is from about 22 to about 168; and the weight ratio of the (c) silane having good leaving groups that is different than (b) is from 22 to about 160.

In the absorbing spin-on-glass compositions, the absorbing compounds may be incorporated interstitially in the spin-on-glass matrix. Alternatively, the absorbing compounds are chemically bonded to the spin-on-glass polymer. Without being bound to any theory, the inventors suggest that bonding of incorporatable absorbing compounds to the spin-on-glass polymer backbone via the accessible reactive groups provides beneficial results.

The 9-anthracene carboxyl-alkyl di- or trialkoxysilanes and 9-anthracene carboxy-alkyl di- or trihalogen silanes may be made using a similar process.

To produce the absorbing spin-on-glass compositions, the absorbing compounds, such as absorbing compounds 1-37, or combinations thereof, are combined with the silane reactants during the synthesis of the SOG materials.

In a first method, a reaction mixture including silane reactants, for example HTEOS, or TEOS and MTEOS, or, TMOS and MTMOS; or, alternatively, tetrachlorosilane and methyltrichlorosilane, one or more absorbing compounds, such as absorbing compounds 1-37; a solvent or combination of solvents; and an acid/water mixture, is formed in a reaction vessel. Appropriate solvents include acetone, 2-propanol, and other simple alcohols, ketones and esters such as 1-propanol, MIBK, propoxypropanol, and propyl acetate. The acid/water mixture is, for example nitric acid and water. Other protic acids or acid anhydrides, such as acetic acid, formic acid, lactic acid, phosphoric acid, hydrochloric acid or acetic anhydride are alternatively used in the acid mixture. The resulting mixture is refluxed for between approximately 1 and 24 hours to produce the absorbing SOG polymer solution.

According to a second method of forming absorbing SOG materials, a reaction mixture including silane reactants, one or more of absorbing compounds, such as absorbing compounds 1-37, and a solvent or combination of solvents is formed in a reaction vessel. The reaction mixture is heated for between approximately 1 and 24 hours. The silane reactants and solvents are as described in the first method above. An acid/water mixture, as described above, is added to the reaction mixture while stirring. The resulting mixture is heated to reflux and refluxed for between approximately 1 and 24 hours to produce the absorbing SOG polymer. The absorbing SOG is diluted and filtered as described above to form a coating solution.

A method of forming an absorbing organohydridosiloxane material includes forming a mixture of a dual phase solvent which includes both a non-polar solvent and a polar solvent and a phase transfer catalyst; adding one or more organotrihalosilane, hydridotrihalosilane, and one or more of absorbing compounds, such as absorbing compounds 1-37, to provide a dual phase reaction mixture; and reacting the dual phase reaction mixture for between 1 and 24 hours to produce the absorbing organohydridosiloxane polymer. The phase transfer catalyst includes but is not limited to tetrabutylammonium chloride and benzyltrimethylammonium chloride. Exemplary non-polar solvents include, but are not limited to, pentane, hexane, heptane, cyclohexane, benzene, toluene, xylene, halogenated solvents such as carbon tetrachloride and mixtures thereof. Useful polar solvents include water, alcohols, and alcohol and water mixtures. The absorbing polymer solution is diluted and filtered as described above to form a coating solution.

### pH Tuning Agent:

The present siloxane polymer family may include at least one pH tuning agent as disclosed in our commonly assigned Spin-On Anti-Reflective Coatings for Photolithography patent application also filed on Nov. 15, 2001, incorporated herein by reference in its entirety to the extent necessary to complete this disclosure.

The pH tuning agent is a compound, material or solution that is added to the mixture of the spin-on material and the organic absorbing compound in order to “tune” or adjust the pH of the final spin-on composition so that it is compatible or more compatible with any chosen resist material, including those with absorption peaks around 365 nm, 248 nm, 193 nm and 157 nm.

It should be appreciated, however, that the pH tuning agent not only adjusts the pH of the final spin-on composition, but it also influences the chemical performance and characteristics, mechanical performance and structural makeup of the final spin-on composition that is part of the layered material, electronic component or semiconductor component, such that the final spin-on composition is more compatible with the resist material that is coupled to it. More specifically, the pH tuning agent strong influences the polymeric characteristics, the structural makeup and the spatial orientation that results in increasing the surface properties of the anti-reflective coating for optimal resist performance. In other words, a pH tuning agent that merely adjusts the pH of the spin-on material without influencing the mechanical properties and structural makeup of the spin-on composition or the coupled resist material is not contemplated herein.

Contemplated pH tuning agents must perform two separate and sometimes related functions: a) to influence the pH of the composition to which it is being added; and b) to influence the mechanical performance and/or structural makeup of the spin-on composition, which can also been stated as strongly influencing the polymeric characteristics, the structural makeup and the spatial orientation that results in increasing the surface properties of the anti-reflective coating for optimal resist performance.

Contemplated pH tuning agents are partly designed to influence the pH of the composition to which it is added. The class of potential pH tuning agents comprises a) any suitable acidic or basic solution, compound, and/or component and/or b) any suitable strength or concentration of an acidic or basic solution, compound and/or component. This compilation of suitable pH “influencers” is the larger set of compound from which the ultimate pH tuning agent is chosen, because the pH “influencer” must also be able to influence the mechanical performance and/or structural makeup of the final spin-on composition while also making the final spin-on composition compatible or more compatible. By this, for example, it is meant that the chosen pH tuning agent is also designed to match the solubility parameter, the molecular weight, the melting point or some other physical characteristic of the spin-on material and organic absorbing compound mixture. In other words, the pH tuning agent and the mixture of spin-on material and organic absorbing compound cannot be physically incompatible, depending on the desirable physical characteristic, even if the pH tuning agent performs its first function of influencing the pH of the mixture. In preferred embodiments, the desirable physical characteristic is the solubility parameter or the molecular weight. In more preferred embodiments, the desirable physical characteristic is the solubility parameter.

It is also contemplated that the pH tuning agent will also mechanically and structurally influence the performance and characteristics of the resist material/ARC couple. For example, a pH tuned spin-on composition is applied to a substrate or layered material, and then a resist material is applied to the spin-on composition. When the resist material is exposed and subsequently etched, the resist material that is at the etching line, etch line or side wall will have an 85-90 degree angle with respect to the spin-on composition. In other words, the resist material will not “fall over” onto the spin-on composition. In the case where the spin-on composition is not pH tuned, the resist material may “fall over” onto the spin-on composition after etching, which obviously leads to a defective layered material. It is in this instance where the pH tuned spin-on composition influences the mechanical and structural integrity of the final spin-on composition and the compatibility of the resist material/ARC couple. As used herein, the terms “coupled” or “couple” mean that the two materials or compositions are juxtaposed on top of one another to the point where the two materials are physically, mechanically and/or chemically bonded to one another.

Examples of some suitable pH tuning agents comprise various molar concentrations of the class of amines, such as -aminoalkyltrialkoxysilanes, specifically—aminopropyltriethoxysilanes (APTF or APTEOS); water; oxides and alkoxides, such as sodium alkoxides, potassium alkoxides, potassium hydroxide; hydrogen halides, such as hydrogen bromide, hydrochloric acid; acetic acid; sulfuric acid, lactic acid, nitric acid; TMAH; PGMEA; and amine-based oligomers, including those oligomers with inorganic atoms such as silicon. Contemplated molar concentrations of the pH tuning agent include 1 Molar, 0.1 Molar and 0.01 Molar concentrations.

Contemplated resist materials may comprise any photolithographic resist materials, including those that have wavelength ranges around 157 nm, 193 nm, 248 nm and 365 nm. The major reason that the class of resist materials is so broad is that the pH tuning agent makes it possible to match any photolithographic resist material with an anti-reflective coating and make them compatible with one another. Examples of some contemplated photolithographic resist materials comprise acrylate-based resist materials, epoxy-based chemically amplified resists, fluoropolymer resists, poly(norbornene-maleic anhydride) alternating co-polymers, polystyrene systems and diazonaphthoquinone/novolac resists.

### Utility:

The present compositions are dissolved in appropriate solvents to form coating solutions and applied to various layers of materials in fabricating semiconductor devices. The absorbing spin-on-glass anti-reflective coatings have been designed to be readily integrated into existing semiconductor fabrication processes. Properties that provide integration include developer resistance, thermal stability during standard photoresist processing, and selective removal with respect to underlying layers.

The absorbing SOG may be diluted with appropriate solvents to achieve coating solutions that produce films of various thicknesses. Suitable dilutant solvents include acetone, 2-propanol, ethanol, butanol, methanol, propylacetate, ethyl lactate, and propylene glycol propyl ether, referred to commercially as Propasol-P. Dilutant solvents with high boiling points such as ethyl lactate and propylene glycol propyl ether have been found beneficial. It is believed high boiling point solvents decrease the probability of formation of bubble film defects. In contrast, lower boiling point solvents may become entrapped below a crosslinked top layer of a film and subsequently produce voids when driven off during a baking process step. Additional solvents useful in the invention include ethylene glycol dimethyl ether, alternatively termed glyme, anisole, dibutyl ether, dipropyl ether, propylene glycol methyl ether acetate, and pentanol. Optionally, surfactants, such as the product FC430, provided by 3M (Minneapolis, Minn.), or the product Megaface R08, provided by DIC (Japan), are also added to the coating solution. The coating solution is typically between about 0.5 and 20% polymer by weight. Prior to use, the coating solution is filtered by standard filtration techniques.

Film thickness range from preferably about one to about 5000 Angstroms, more preferably about 50 to about 3500 Angstroms, and most preferably about 500 to 1500 Angstroms.

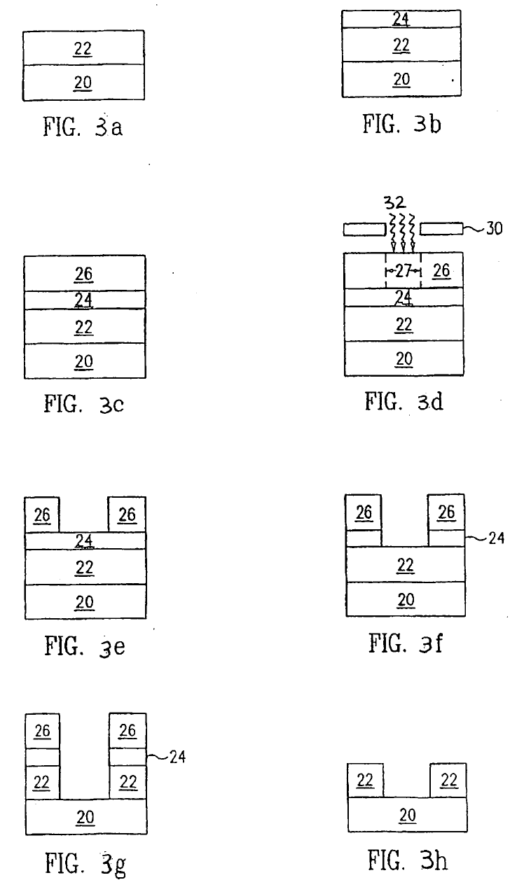

A general method of using an absorbing spin-on-glass material according to the present invention as an anti-reflective coating in a photolithographic process is illustrated in FIGS. 3a-3h. As shown in FIG. 3a, a dielectric layer 22 is deposited on a silicon substrate 20. Dielectric layer 22 may be composed of a variety of dielectric materials including, for example, a silicon dioxide layer derived from TEOS, a silane based silicon dioxide layer, a thermally grown oxide, or a chemical-vapor-deposition-produced methylhydridosiloxane or silicon dioxide incorporating other elements or compounds. Dielectric layer 22 may be typically an optically transparent medium but does not have to be. An absorbing SOG anti-reflective coating layer 24 is applied above dielectric layer 22 (FIG. 3b) which is covered by a photoresist layer 26, of a conventional positive photoresist, to produce the stack shown in FIG. 3c. The stack of FIG. 3c is exposed to ultraviolet radiation 32 through mask 30, as shown in FIG. 3d. During the exposure, the absorbing SOG ARC layer 24 absorbs UV light 32 transmitted through the photoresist. Because the dielectric layer 22 is transparent in the UV wavelength range, if absorbing SOG ARC layer 24 were not present, the UV light 32 would reflect off the underlying silicon layer 20 degrading a critical dimension, for example critical dimension 27 of the exposed photoresist. In this example, a positive photoresist, which provides direct image transfer, is assumed.

The exposed stack is developed to produce the stack of FIG. 3e. The absorbing SOG ARC layer 24 is resistant to conventional photoresist developer solutions such as a 2.5% solution of tetramethylammoniumhydroxide (TMAH). In contrast, organic ARC layers, which have some of the chemical characteristics of the photoresist materials, are more sensitive to photoresist developers. Furthermore, it is anticipated that absorbing SOG ARC layers are resistant to reducing chemistry, gas-based, photoresist stripping processes, whereas organic ARC's are not resistant. Thus, use of absorbing SOG layers may facilitate photoresist rework, without the need to reapply the ARC layer.

Next, a pattern is etched in the absorbing SOG ARC layer 24 through the opening in photoresist layer 26 to produce the etched stack of FIG. 3f. A fluorocarbon etch, which has a high selectivity to photoresist, is used to etch the absorbing SOG ARC layer 24. The response of the absorbing SOG to a fluorocarbon etch provides an additional advantage of the absorbing SOG over organic ARC layers, which require an oxygen plasma etch. An oxygen plasma etch can degrade the critical dimension of the developed photoresist because the photoresist, being organic based, is also etched by an oxygen plasma. A fluorocarbon plasma consumes less photoresist than an oxygen plasma. At shorter UV wavelengths, depth of focus requirements will limit the thickness of photoresist layer 26 at the exposure step shown in FIG. 3d. For example, it is estimated that at 193 nm, the thickness of photoresist layer should be approximately 300 nm. Thus, as these short wavelengths start to be employed, it will be important to have an ARC layer that can be etched selectively with respect to the photoresist.

The fluorocarbon etch is continued through the dielectric layer 22 to produce the stack of FIG. 3g. Photoresist layer 26 is partially consumed during the continued etch process. Finally, the photoresist layer 26 is stripped using an oxygen plasma or a hydrogen reducing chemistry, or wet stripping, and the SOG ARC layer 24 is stripped using either a buffered oxide etch, for example a standard hydrofluoric acid/water mixture, or an aqueous or non-aqueous organoamine, or aqueous or non-aqueous fluoride solvents. Advantageously, the SOG ARC layer can be stripped with solutions that show a good selectivity with respect to the underlying dielectric layer. Thus, the general photolithographic method shown in FIGS. 3a-3h illustrate the process advantages of absorbing SOG materials as anti-reflective coating layers.

As an example of using the saddle or concave/convex relationship of the present siloxane polymer, start with a design goal such as extinction coefficient or refractive index. From that saddle, determine the starting ratios that will achieve the goal. For example, if the selected design goal is k=0.28, locate 0.28 on the z axis and relate it to the ratios of the starting materials on the x and y axis. For each of these ratios found on the primary design goal saddle, note where these ratios fall on the secondary design goal saddle(s). Of the possible choices on the secondary design goal saddles, determine which ratios are the most advantageous. Again for example, k=0.28 had a PTEOS to MTEOS ratio of A and the PTEOS/TEOS ratio of B. On the BOE etch rate saddle ratio, observe that A has an etch rate of R and B has an etch ratio of E. Assume that the secondary design goal is fast BOE etch and note that R etches faster than E. By choosing the molar ratios of A as the preferred ratio, the design is a specific k and optimized for a secondary design goal of BOE etch rate. This process may be repeated for a multitude of secondary design goals and there may be many more than two ratios that will achieve the primary design goal.

FTIR and proton nmr may be useful analytical techniques in the present invention.

### Analytical Test Methods:

Optical Properties and Thickness: Extinction coefficient (k) was determined by using n&k Technology Inc.'s 1200 and 1512 tool to measure the reflectance spectrum and then using n&k Technology Inc.'s software to calculate thickness, n, and k from the measured reflectance.

The methods of synthesizing the present compositions are illustrated in the following examples.

### PREPARATION EXAMPLES

### Synthesis of 9-anthracene carboxy-methyl triethoxysilane

In a 2 L flask, 90.0 g 9-anthracenecarboxylic acid, 86.0 ml chloromethyltriethoxysilane, 66 ml triethylamine, and 1.25 L methylisobutylketone (MIBK) that had been dried over 4 Å molecular sieves were stirred, heated slowly to reflux and refluxed for 8.5 hours. The solution was transferred to a 2L Teflon bottle and left overnight. A large quantity of solid precipitate formed. The MIBK solution was decanted and roto-evaporated to about 200 g. An equal weight of hexane was added and mixed. A precipitate formed. A 1.75 inch diameter by 2 inch high column of silica gel slurried with 20% ethylacetate/80% hexane was prepared. The MIBK/hexane solution was passed through the column under pressure and the column washed with 800 ml of 20% ethylacetate/80% hexane. The solution was filtered to 0.2 fm and roto-evaporated. When the solvent stopped coming off, the temperature was raised to 35° C. for 60 minutes. A dark amber oily liquid product was obtained (85 g).

### Synthesis of 9-anthracene carboxy-ethyl triethoxysilane

In a 2 L flask, 90.0 g 9-anthracenecarboxylic acid, 86.0 ml chloroethyltriethoxysilane, 66 ml triethylamine, and 1.25 L methylisobutylketone (MIBK) that had been dried over 4 Å molecular sieves is stirred, heated slowly to reflux and refluxed for 8.5 hours. The solution is transferred to a 2L Teflon bottle and left overnight. A large quantity of solid precipitate forms. The MIBK solution is decanted and roto-evaporated to about 200 g. An equal weight of hexane is 20 added and mixed. A precipitate formed. A 1.75 inch diameter by 2 inch high column of silica gel slurried with 20% ethylacetate/80% hexane is prepared. The MIBK/hexane solution is passed through the column under pressure and the column washed with 800 ml of 20% ethylacetate/80% hexane. The solution is filtered to 0.2 μm and roto-evaporated. When the solvent stopped coming off, the temperature is raised to 35° C. for 60 minutes.

### Synthesis of 9-anthracene carboxy-propyl triethoxysilane

In a 2 L flask, 90.0 g 9-anthracenecarboxylic acid, 86.0 ml chloropropyltriethoxysilane, 66 ml triethylamine, and 1.25 L methylisobutylketone (MIBK) that had been dried over 4 Å molecular sieves were stirred, heated slowly to reflux and refluxed for 8.5 hours. The solution was transferred to a 2L Teflon bottle and left overnight. A large quantity of solid precipitate formed. The MIBK solution was decanted and roto-evaporated to about 200 g. An equal weight of hexane was added and mixed. A precipitate formed. A 1.75 inch diameter by 2 inch high column of silica gel slurried with 20% ethylacetate/80% hexane was prepared. The MIBK/hexane solution was passed through the column under pressure and the column washed with 800 ml of 20% ethylacetate/80% hexane. The solution was filtered to 0.2 μm and roto-evaporated. When the solvent stopped coming off, the temperature was raised to 35° C. for 60 minutes.

### Synthesis of 9-anthracene carboxy-methyl trimethoxysilane

In a 2 L flask, 90.0 g 9-anthracenecarboxylic acid, 86.0 ml chloromethyltrimethoxysilane, 66 ml triethylamine, and 1.25 L methylisobutylketone (MIBK) that had been dried over 4 Å molecular sieves is stirred, heated slowly to reflux and refluxed for 8.5 hours. The solution is transferred to a 2L. Teflon bottle and left overnight. A large quantity of solid precipitate forms. The MIBK solution is decanted and roto-evaporated to about 200 g. An equal weight of hexane is added and mixed. A precipitate forms. A 1.75 inch diameter by 2 inch high column of silica gel slurried with 20% ethylacetate/80% hexane is prepared. The MIBK/hexane solution is passed through the column under pressure and the column washed with 800 ml of 20% ethylacetate/80% hexane. The solution is filtered to 0.2 μm and roto-evaporated. When the solvent stops coming off, the temperature is raised to 35° C. for 60 minutes.

### Inventive Examples 1-2

The starting materials indicated in Table 1 below for Inventive Example 1 and in Table 2 below for Inventive Example 2 were loaded into a 1-liter flask and combined. The flask was heated from one to 24 hours. Solvents were added to achieve the desired film thickness and in the amounts set forth in the Tables. The solution was filtered. The solution was dispensed, followed by a 3000 rpm thickness spin for 20 seconds, and baked at 80° C. and at 180° C. for one minute each. Optical properties were measured with an n&k Technology Inc.'s 1512 tool.

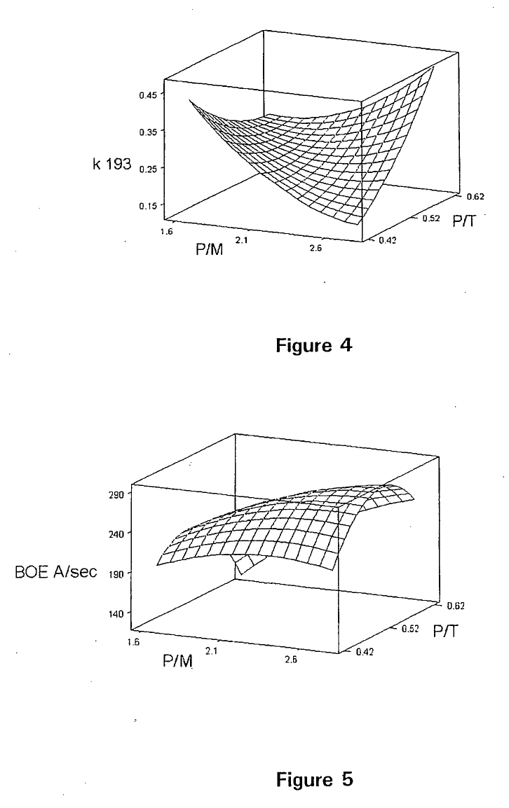

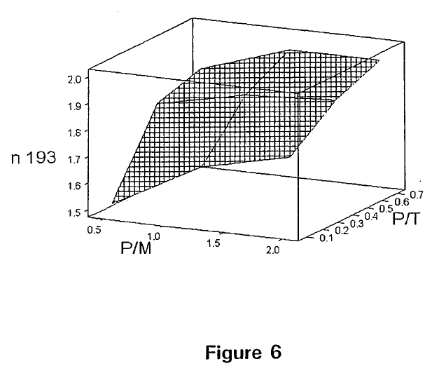

In Inventive Example 1, compositions A through M described in Table 1 below absorb at 193 nanometers. FIGS. 4-6 resulted from this data. In Table 1, P and PTEOS stand for phenyltriethoxysilane, M and MTEOS stand for methyltriethoxysilane, and T and TEOS stand for tetraethoxysilane.

TABLE 1

| Inventive | | | Grams | Moles | Grams | Moles | Grams | moles |
|---|---|---|---|---|---|---|---|---|
| Example 1 | P/M | P/T | PTEOS | PTEOS | MTEOS | MTEOS | TEOS | TEOS |
| A | 0.5 | 0.1 | 22.62 | 0.093545 | 33.5 | 0.187991 | 147.02 | 0.705572 |
| B | 2 | 0.1 | 25.57 | 0.105744 | 9.48 | 0.053199 | 166.2 | 0.79762 |
| C | 0.5 | 0.7 | 66.39 | 0.274554 | 98.5 | 0.55275 | 61.65 | 0.295868 |
| D | 2 | 0.7 | 100.4 | 0.415202 | 37.24 | 0.208979 | 93.23 | 0.447425 |
| E | 0.5 | 0.4 | 53.46 | 0.221083 | 79.31 | 0.445062 | 86.88 | 0.416951 |
| F | 2 | 0.4 | 73.51 | 0.303999 | 27.26 | 0.152974 | 119.46 | 0.573307 |
| G | 0.5 | 0.4 | 53.46 | 0.221083 | 79.31 | 0.445062 | 86.88 | 0.416951 |
| H | 2 | 0.4 | 73.51 | 0.303999 | 27.26 | 0.152974 | 119.46 | 0.573307 |
| I | 1.25 | 0.1 | 24.92 | 0.103056 | 14.79 | 0.082997 | 161.97 | 0.777319 |
| J | 1.25 | 0.7 | 91.07 | 0.376618 | 54.04 | 0.303255 | 84.57 | 0.405865 |
| K | 1.25 | 0.1 | 24.92 | 0.103056 | 14.79 | 0.082997 | 161.97 | 0.777319 |
| L | 1.25 | 0.7 | 91.07 | 0.376618 | 54.04 | 0.303255 | 84.57 | 0.405865 |
| M | 1.25 | 0.4 | 68.38 | 0.282784 | 40.58 | 0.227722 | 111.12 | 0.533282 |

| Inventive | | | | | Thickness | | | Etch rate | |
|---|---|---|---|---|---|---|---|---|---|
| Example 1 | MW | density | % solids | Rexp | (Å) | k 193 | n 193 | Å/second | P/M * P/T |
| A | 1223 | 0.8514 | 10.5833 | 7.4 | 3454 | 0.522 | 1.516 | 176.833 | 0.05 |
| B | 1369 | 0.8523 | 10.4627 | 7.7 | 3335 | 0.119 | 1.766 | 209.533 | 0.2 |
| C | 872 | 0.8536 | 12.9091 | 10.1 | 4755 | 0.306 | 1.861 | 131.8 | 0.35 |
| D | 1043 | 0.8585 | 13.6918 | 11.7 | 4461 | 0.371 | 1.966 | 264.467 | 1.4 |
| E | 1095 | 0.8527 | 12.2705 | 8.9 | 3825 | 0.268 | 1.812 | 226.067 | 0.2 |
| F | 579 | 0.8600 | 12.7923 | 10.9 | 4553 | 0.354 | 1.849 | 284.6 | 0.8 |
| G | 818 | 0.8500 | 12.2484 | 9.2 | 4451 | 0.231 | 1.806 | 221.4 | 0.2 |
| H | 572 | 0.8600 | 13.647 | 10.2 | 4120 | 0.27 | 1.946 | 274.267 | 0.8 |
| I | 886 | 0.8500 | 13.1383 | 7.5 | 3394 | 0.253 | 1.647 | 229.033 | 0.125 |
| J | 577 | 0.8600 | 13.6171 | 11.1 | 4274 | 0.311 | 1.973 | 239.6 | 0.875 |
| K | 1174 | 0.8500 | 10.5158 | 7.5 | 3375 | 0.112 | 1.737 | 232.633 | 0.125 |
| L | 576 | 0.8600 | 13.6152 | 11.5 | 4705 | 0.366 | 1.961 | 159.067 | 0.875 |
| M | 741 | 0.8600 | 12.8159 | 10.1 | 4270 | 0.261 | 1.88 | 263.533 | 0.5 |

For Inventive Example 1, the extinction coefficient k value concave/convex shaped relationship (at 193 nanometers) is defined (in grams) by k=1312−4.46 PTEOS (grams)−6.02 MTEOS (grams)+6.86 TEOS (grams). The extinction coefficient k value concave/convex shaped relationship (at 193 nanometers) is defined (in moles) by k=1312−0.018444 PTEOS (moles)−0.033782 MTEOS (moles)−0.032922 TEOS (moles). The etch rate concave/convex shaped relationship (at 193 nanometers) is defined (in grams) by boe=−236966+807 PTEOS (grams)+1087 MTEOS (grams)+1241 TEOS (grams). The etch rate concave/convex shaped relationship (at 193 nanometers) is defined (in grams) by boe=−236966+3.337331 PTEOS (moles)+6.099888 MTEOS (grams)+5.955752 TEOS (moles).

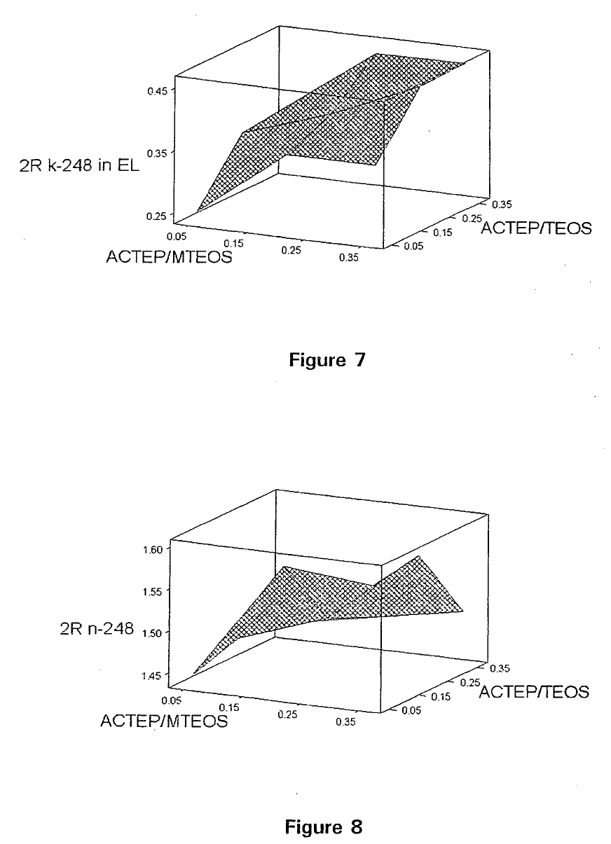

For Inventive Example 2, compositions A through I described in Table 2 below absorb at 248 nanometers. PGMEA stands for propylene glycol methyl ether acetate. FIGS. 7-8 resulted from the ethyl lactate data. S stands for scale factor because limited amounts of starting materials were available.

TABLE 2

| Inventive | Actep/ | Actep/ | grams | Moles | Grams | Moles | Grams | Moles | Grams | Grams |
|---|---|---|---|---|---|---|---|---|---|---|
| Example 2 | MTEOS | TEOS | actep | actep | MTEOS | mteos | TEOS | teos | Acetone | IPA |
| A | 0.36 | 0.36 | 79.59 | 0.186577 | 92.417 | 0.518614 | 80.987 | 0.388669 | 148.56 | 297 |
| B | 0.205 | 0.205 | 48.5084 | 0.113715 | 98.913 | 0.555067 | 86.68 | 0.415991 | 148.56 | 297 |
| C | 0.05 | 0.36 | 21.9433 | 0.05144 | 183.452 | 1.029473 | 22.328 | 0.107156 | 148.56 | 297 |
| D | 0.36 | 0.05 | 21.9433 | 0.05144 | 25.479 | 0.14298 | 160.762 | 0.771522 | 148.56 | 297 |
| E | 0.05 | 0.05 | 12.7259 | 0.029832 | 106.392 | 0.597037 | 93.233 | 0.44744 | 148.56 | 297 |
| F | 0.205 | 0.05 | 20.1623 | 0.047265 | 41.113 | 0.230713 | 147.715 | 0.708907 | 148.56 | 297 |
| G | 0.05 | 0.205 | 20.1623 | 0.047265 | 168.563 | 0.94592 | 36.028 | 0.172904 | 148.56 | 297 |
| H | 0.205 | 0.36 | 60.2787 | 0.141307 | 122.914 | 0.689753 | 61.336 | 0.294361 | 148.56 | 297 |
| I | 0.36 | 0.205 | 60.2787 | 0.141307 | 69.993 | 0.392778 | 107.712 | 0.516927 | 148.56 | 297 |

| Inventive | Grams | Grams | Grams | S | S | | S | | | |
|---|---|---|---|---|---|---|---|---|---|---|
| Example 2 | Acid | Water | Butanol | TESPAC | MTEOS | s TEOS | Acetone | IPA | s Acid | s Water |
| A | 5.599 | 66.86 | 43.77 | 47.754 | 55.45 | 48.592 | 89.136 | 178.2 | 3.3594 | 40.116 |
| B | 5.599 | 66.86 | 43.77 | 29.105 | 59.348 | 52.0077 | 89.136 | 178.2 | 3.3594 | 40.116 |
| C | 5.599 | 66.86 | 43.77 | 13.166 | 110.071 | 13.3969 | 89.136 | 178.2 | 3.3594 | 40.116 |
| D | 5.599 | 66.86 | 43.77 | 13.166 | 15.288 | 96.4573 | 89.136 | 178.2 | 3.3594 | 40.116 |
| E | 5.599 | 66.86 | 43.77 | 7.6355 | 63.835 | 55.94 | 89.136 | 178.2 | 3.3594 | 40.116 |
| F | 5.599 | 66.86 | 43.77 | 12.0974 | 24.668 | 88.6288 | 89.136 | 178.2 | 3.3594 | 40.116 |
| G | 5.599 | 66.86 | 43.77 | 12.0974 | 101.138 | 21.6168 | 89.136 | 178.2 | 3.3594 | 40.116 |
| H | 5.599 | 66.86 | 43.77 | 36.1672 | 73.748 | 36.8015 | 89.136 | 178.2 | 3.3594 | 40.116 |
| I | 5.599 | 66.86 | 43.77 | 36.1672 | 41.996 | 64.627 | 89.136 | 178.2 | 3.3594 | 40.116 |

| | | | | | Parent | Thickness | | |
|---|---|---|---|---|---|---|---|---|
| Inventive | R k-248 | Percent | | | Thickness | PGMEA | 1 R fit k | Dilution Target |
| Example 2 | in EL | deviation | 2R n-248 | Interaction | (Å) | (Å) | PGMEA | for 1500A EL |
| A | 0.451267 | 28.0546 | 1.49493 | 0.1296 | 7095.43 | 1676.9 | 0.448017 | 1.323 |
| B | 0.3892 | 1.1571 | 1.5004 | 0.042025 | 5456.25 | 1441.18 | 0.453617 | 1.161 |
| C | 0.349675 | 8.4845 | 1.45633 | 0.018 | 3271.11 | 574.89 | 0.396917 | 0.587 |
| D | 0.3587 | 0.0966 | 1.57793 | 0.018 | 3692.4 | 1138.95 | 0.227367 | 0.816 |
| E | 0.251358 | 23.3796 | 1.44577 | 0.0025 | 3629.76 | 822.31 | 0.283917 | 0.74 |
| F | 0.359067 | 0.279 | 1.5883 | 0.01025 | 3832.35 | 1076.2 | 0.218675 | 0.849 |
| G | 0.342833 | 4.8852 | 1.46417 | 0.01025 | 3497.5 | 738.33 | 0.29315 | 0.691 |
| H | 0.450567 | 11.0757 | 1.47567 | 0.0738 | 6000.26 | 1502.89 | 0.475083 | 1.219 |
| I | 0.449933 | 13.731 | 1.58793 | 0.0738 | 5988.06 | 1666.48 | 0.426833 | 1.233 |

For Inventive Example 2, in ethyl lactate diluent, the extinction coefficient k value concave/convex shaped relationship (at 248 nanometers) is defined (in grams) by k=−37172+71.2 ACTEP (grams)+170 MTEOS (grams)+194 TEOS (grams). In ethyl lactate diluent, the extinction coefficient k value concave/convex shaped relationship (at 248 nanometers) is defined (in moles) by k=−37172+0.166909 ACTEP (moles)+0.953984 MTEOS (moles)+0.0931036 TEOS (moles). In PGMEA diluent, the extinction coefficient k value concave/convex shaped relationship (at 248 nanometers) is defined (in grams) by k=−64281+123 ACTEP (grams)+295 MTEOS (grams)+336 TEOS (grams). In PGMEA diluent, the extinction coefficient k value concave/convex shaped relationship (at 248 nanometers) is defined (in moles) by k=−64281+0.28834 ACTEP (moles)+1.655443 MTEOS (moles)+1.612516 TEOS (moles). In ethyl lactate diluent, the refractive index n concave/convex shaped relationship (at 248 nanometers) is defined (in grams) by n=−32132+61.6 ACTEP (grams)+147 MTEOS (grams)+168 TEOS (grams). In ethyl lactate diluent, the refractive index n concave/convex shaped relationship (at 248 nanometers) is defined (in moles) by n=−32132+0.144404 ACTEP (moles)+0.824916 MTEOS (moles)+0.806258 TEOS (moles). Teri—Does a thickness saddle exist for the following: thickness=38900107−74493 ACTEP (grams)−178346 MTEOS (grams)+203514 TEOS (grams). Thickness=38900107−174.6284 ACTEP (moles)−1000.819 MTEOS (moles)−976.6953 TEOS (moles).

Although the invention has been described with reference to particular examples, the description is only an example of the invention's application and should not be taken as a limitation. Various adaptations and combinations of features of the examples disclosed are within the scope of the invention as defined by the following claims.

We claim:

1. A siloxane polymer made from
(a) phenylalkoxysilane that strongly absorbs light at wavelengths less than about 365 nanometers; and
(b) at least one silane having good leaving groups.

2. The siloxane polymer of claim 1 additionally comprises (c) at least one silane having alkoxy groups that is different than (b).

3. The siloxane polymer of claim 1 wherein said phenyalkoxysilane strongly absorbs light at wavelengths less than about 200 nanometers.

4. The siloxane polymer composition of claim 2 wherein said (b) and (c) are selected from triethoxysilane, tetraethoxysilane, methyltriethoxysilane, dimethyldiethoxysilane, tetramethoxysilane, methyltrimethoxysilane, trimethoxysilane, dimethyidimethoxysilane, phenyltrimethoxysilane, trichlorosilane, methyltrichlorosilane, ethyltrichlorosilane, tetrachlorosilane, chlorotriethoxysilane, chlorotrimethoxysilane, chloromethyltriethoxysilane, chloroethyltriethoxysilane, chloromethyltrimethoxysilane, and chloroethyltrimethoxysilane.

5. A solution comprising said siloxane polymer of claim 1 and a solvent or a solvent mixture.

6. The solution of claim 5 wherein the solution is between about 0.5% and about 20% by weight of said siloxane polymer.

7. A film comprising said solution of claim 5.

8. A sacrificial material comprising said solution of claim 5.

9. An integrated circuit device comprising said film of claim 7.

10. A siloxane polymer family comprising siloxane polymer made from:
a (a) a strongly absorbing compound;
(b) at least one silane having good leaving groups; and
b (C) at least one silane having good leaving groups that is different than (b);
wherein said siloxane polymer family exhibits a relationship that is concave/convex or is located in the region enclosed by a concave/convex relationship for the ratio of said (a) to said (b) to said (c) and said siloxane polymer's k value.

11. The siloxane polymer family of claim 10 wherein said siloxane polymer family exhibits a relationship that is concave/convex or is located in the region enclosed by a concave/convex relationship for the ratio of said (a) to said (b) to said (c) and said siloxane polymer's etch rate.

12. The siloxane polymer family of claim 11 wherein said siloxane polymer family exhibits a relationship that is concave/convex or is located in the region enclosed by a concave/convex relationship for the ratio of said (a) to said (b) to said (c) and said siloxane polymer's r efractive index.

13. The siloxane polymer family of claim 10 wherein the weight ratio of said (a) is from about 22 to about 100; the weight ratio of said (b) is from about 9 to about 98; and the weight ratio of said (c) is from about 61 to about 162.

14. The siloxane polymer family. of claim 10 wherein the weight ratio of said (a) is from about 12 to about 60; the weight ratio of said (b) is from about 22 to about 168; and the weight ratio of said (c) is from 22 to about 160.

15. The siloxane polymer family of claim 10 wherein said (c) strongly absorbs light at wavelengths less than about 365 nanometers.

16. The siloxane polymer family of claim 15 wherein said ( c) comprises 9-anthracene carboxy-alkyl di- or trialkoxysilane wherein the alkyl has from 1 to 4 carbon atoms and the alkoxy has 1 to 4 carbon atoms; 9-anthracene carboxy-alkyl di- or trihalogensilane wherein the alkyl has from 1 to 4 carbon atoms; 2-hydroxy-4-(3-triethoxysilylpropoxy)-diphenylketone; 2-hydroxy-4-(3-trimethoxysilylpropoxy)-diphenylketone; 2-hydroxy-4-(3-tributoxysilyipropoxy)-diphenylketone; 2-hydroxy-4-(3-tripropoxysilylpropoxy)-diphenylketone; rosolic acid; triethoxysilylpropyl-1,8-naphthalimide; trimethoxysilylpropyl-1,8-naphthalimide; tripropoxysilylpropyl-1,8-naphthalimide; 9-anthracene carboxy-methyl triethoxysilane; 9-anthracene carboxy-ethyl triethoxysilane; 9-anthracene carboxy-butyl triethoxysilane; 9-anthracene carboxy-propyl triethoxysilane; 9-anthracene carboxy-methyl trimethoxysilane; 9-anthracene carboxy-ethyl tributoxysilane; 9-anthracene carboxy-methyl tripropoxysilane; 9-anthracene carboxy-propyl trimethoxysilane; phenyltriethoxysilane; phenyltrimethoxysilane; phenyitripropbxysilane; 4-phenylazophenol; 4-ethoxyphenylazobenzene-4-carboxy-methyl triethoxysilane; 4-methoxyphenylazobenzene-4-carboxy-ethyl triethoxysilane; 4-ethoxyphenylazobenzene-4-carboxy-propyl triethoxysilane; 4-butoxyphenylazobenzene-4-carboxy-propyl triethoxysilane; 4-methoxyphenylazobenzene-4-carboxy-methyl triethoxysilane; 4-ethoxyphenylazobenzene-4-carboxy-methyl triethoxysilane; 4-methoxyphenylazobenzene-4-carboxy-ethyl triethoxysilane; 4-methoxyphenylazobenzene-4-carboxy-propyl triethoxysilane and mixtures thereof.

17. The siloxane polymer family of claim 10 which additionally comprises (d) at least one pH tuning agent.

18. A solution comprising the siloxane polymer family of claim 10 and a solvent or a solvent mixture.

19. The solution of claim 18 wherein the solution is between about 0.5% and about 20% by weight of said siloxane polymer family.

20. A spin-on material comprising said solution of claim 18

21. A film comprising said spin-on material of claim 20.

22. A sacrificial material comprising said siloxane polymer family of claim 10.

23. An integrated circuit device comprising said film of claim 21.

24. A method of achieving a spin-on glass composition having tuned optical properties and maximum etch rate comprising the steps of:
(a) using a siloxane polymer family comprising siloxane polymer made from:
(i) a strongly absorbing compound;
ii (ii) at least one silane having good leaving groups; and
(iii) at least one silane having good leaving groups that is different than (ii),
wherein said siloxane polymer family exhibits a relationship that is concave/convex or is located in the region enclosed by a concave/convex relationship for the ratio of said (i) to said (ii) to said (iii) and said siloxane polymer's k value;
(b) selecting a k value; and
(c) selecting the ratio of said (i) to said (ii) to said (iii) that optimizes etch rate of said siloxane polymer.
